(19) United States
(12) Patent Application Publication
(10) Pub. No.: US 2005/0132699 A1
(43) Pub. Date: Jun. 23, 2005

(54) Converting pressure energy from renewable energy sources into electrical energy

(76) Inventor: Edwin Newman, Toluca Lake, CA (US)

Correspondence Address: Edwin Newman;Unit #3, 11038 Camarillo St., Toluca Lake, CA, 91602, US

(21) Appl. No.: 10/742,983

(22) Filed: Dec. 23, 2003

(51) Int. Cl. F16D 31/02

(52) U.S. Cl. 60/398

(57) ABSTRACT

A new type of diverging nozzle is used to convert wind energy and subsurface ocean current energy into electrical energy. A new design for an atmospheric engine uses a pressure energy sink created by fluid flow through the small end of the diverging nozzle. An esthetically pleasing and economical way is presented to convert wind energy into electricity. Offshore, no moving parts are employed.

### BACKGROUND OF THE INVENTION

1. Field of the Invention

The present invention relates to the conversion of the energy of the wind and subsurface ocean currents into electrical energy. In particular the invention relates to the conversion of pressure energy from these sources into electrical energy.

2. The Prior Art

Wind and subsurface ocean currents are fluids possessing mechanical energy. The two relevant components of mechanical energy are pressure energy and kinetic energy. Up to now only some few efforts hve been made to convert the pressure energy of these fluids into electricity. Yet the pressure energy of these two fluids as they naturally occur is far greater than their kinetic energy.

Hydroelectric turbine generators are a prime example of devices which convert pressure energy into electrical energy. A pressure head is artificially built up in differentiation with the pressure of the surrounding atmosphere. Theoretical power output is calculated as this pressure difference multiplied by the rate of flow.

The relevant technology for converting the pressure energy of the wind into electrical energy is U.S. Pat. No. 5,709,419 to Roskey. Pressure energy is converted to kinetic energy by using a Venturi flume with the kinetic energy compounded with the use of a manifold. The manifold lies outside the Venturi flume so the advantage of using a manifold is also minimized since pipe friction can be very great.

For converting the pressure energy of subsuface ocean currents into electricity the U.S. patent most relevant to this invention is U.S. Pat. No. 6,568,181 B1 to Hassard et al. Here an airflow is drawn through an air turbine ashore through a pipe to an offshore Venturi tube's throat, as may sometimes be observed with a manometer. The speed of the current as it is accellerated through the throat determines the speed of the airflow. But to avoid large energy losses through the airpipe due to friction a large and expensive pipe is needed.

This problem is overcome by the present invention.

### SUMMARY OF THE INVENTION

There is first of all a teardrop-shaped object elevated into the midst of a fluid current. The object is oriented so its blunt end is made to face the oncoming current. The object is in two separate portions the division being on a plane through the object's widest diameter called an anterior dome and either a posterior cone or a posterior dome. There is sufficient structure to unite the separated parts of the object together. Through the center of the anterior dome shped portion is a hole and by this hole is a tube leading to an atmospheric engine apparatus elsewhere. As fluid flows past this teardrop shaped object fluid tends to be drawn through this hole at high velocity and out between the rims of the anterior and posterior portions of the object at the prevailing current velocity.

The working fluid within the atmospheric engine is water. The waterline is at the end of the tube near the hole in the anterior dome.

The first object of this invention is to overcome the stated problem of the prior art.

The second object is to provide inexpensive and effective electric power from wind and subsurface ocean currents.

The attainment of the foregoing and related objects, features and advantages should be more readily apparent to those skilled in the relevant arts after a review of the following more detailed description of the invention, taken together with the drawings in which:

### BRIEF DESCRIPTION OF THE DRAWINGS

FIG. 1 is a perspective view of the invention where the passing fluid is the wind.

FIG. 2. is a perspective view of the invention as it applies to subsurface ocean currents.

FIG. 3. is a view of the energy conversion apparatus of the invention.

### DETAILED DESCRIPTION OF THE INVENTION

### FIRST PREFERRED EMBODIMENT

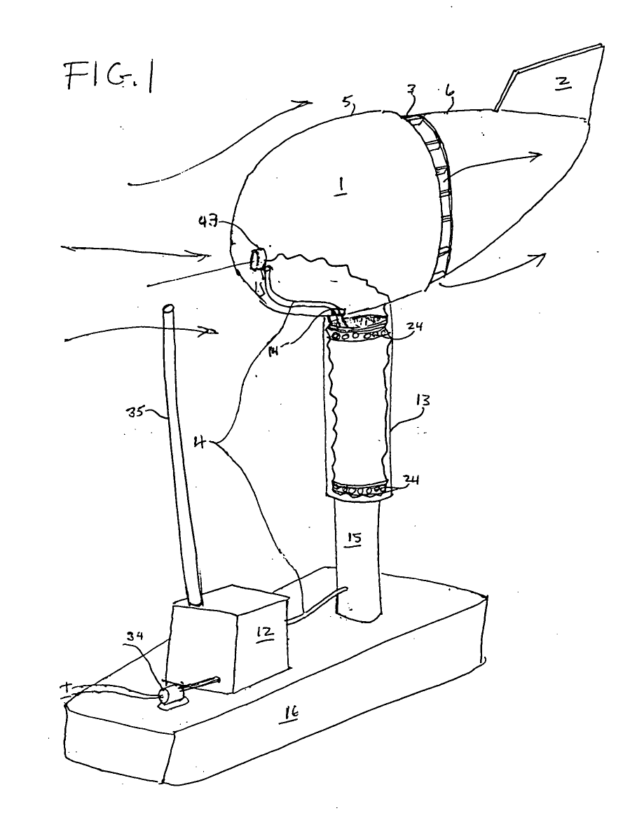

Turning to FIG. 1 we see base 16 upon which the invention rests. Erected on base 16 is hollow pole 15. Telescoped over pole 15 is pole 13 upon which teardrop-shaped object 1 is fixedly attached. Thrust bearings 24 alows object 1 and pole 13 to revolve concentricly about pole 15 as governed by the response of fin 2 to the prevailing wind. Races in the wall of pole 13 prevent the vertical motion of hollow object 1.

Pipe 4 is concentric with pipes 13,15 and has a moveable connection 14 allowing that section of pipe 4 above connection 14 to rotate as teardrop shaped object 1 is made to rotate by the wind. The rims of anterior dome 5 and posterior cone 6 are connected by struts 3 positioned so air can pass through the struts.

Pipe 4, which is full of water, is led to atmospheric engine 12.

### SECOND PREFERRED EMBODIMENT

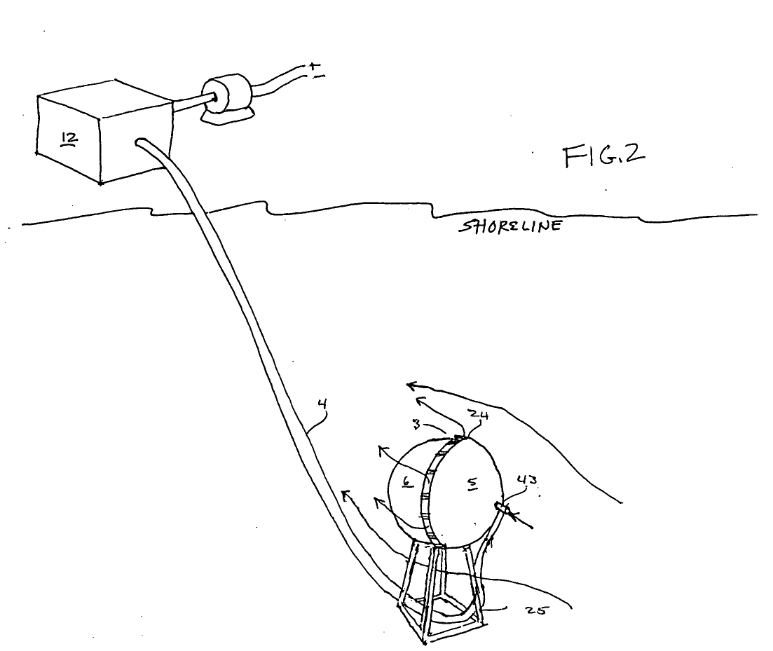

Turning now to FIG. 2 we see instead of a teardrop shaped object a spherical object 24 fixedly attached to tower 25 which in its turn is fixedly attached to the ocean floor. Anterior dome 5 nd posterior dome 6 as well as pipe 4 and struts 3 exist as in the First Preferred Embodiment.

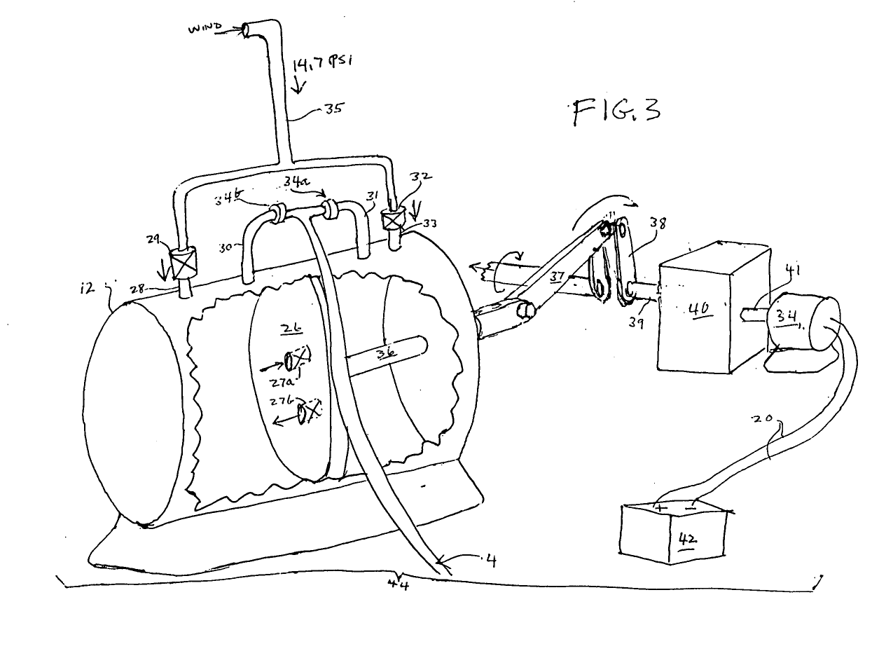

Ashore pipe 4 is led into energy conversion apparatus 44. In FIG. 3 all the parts of energy conversion apparatus 44 are shown. Atmospheric engine 12 contains piston 26 which in its turn has two passages through it, each containing a check valve 27a,27b. These valves each allow water to pass in opposite directions. Arrow directions show the flow of water in operation of the invention. Items 29,32 are also check valves, pipes 28,30 are led into the volume of the engine to the left of piston 26 and pipes 31,33 are led into the volume of the engine to the right of piston 26 Pipe 35 is an air inlet and pipe 4 leads to the object.

Both pipes are filled with water to the same level. Valve control may be effectuated by mechanical devices as in U.S. Pat. No. 32,455(Shaw) or U.S. Pat. No. 170,813(Burger) or by electronic devices which are not a part of this invention. Shaft 36 is driven by piston 26 and is connected to shaft 37 to be mde to rotate cam 38. Shafts 39,41, drive gear transmission 40 and D.C. generator 34, which is connected to output cable 20 and battery 42.

In operation,water current flowing past sphere 24 draws water through inlet 43 at a faster rate than the velocity of the current. This lowers the water pressure in pipe 4 providing an energy sink to drive atmospheric engine 12. To move piston 26 to the right valves 29,34a are opened and valves 32,34b are closed.

Once the maximum pressure differential is established valve 34a is closed. Or valve 34b at this point in the cycle if motion of piston 26 is to be to the left.

Pipes 4,30,31 and 35 as well as the volumes on both sides of piston 26 are water-filled. Assuming a water current flowing past sphere 24 the absolute water pressure of the volume of wter to the right of piston 26 as shown in FIG. 3 will fall below atmospheric pressure. But the water in the volume to the left of piston 26 will be maintained at atmospheric pressure. The size of the valve openings 27a,b must be controlled to be such that as piston 26 is forced to the right by the uneven pressure on either side of piston 26 the resulting displacement of water through valve 27b will result in no transfer of pressure through valve 27b.

Movement of piston 26 to the right causes cam 38 to be made to revolve clockwise crankshaft 39 which in its turn is made to operate D.C. generator 34 causing electricity to be fed into battery 42. Crankshaft 39 may be connected to other atmospheric engines 12 to insure less fluctuation in power output.

Motion of piston 26 to the left is accomplished by opening vlves 32,34b and simultaneously closing valves 29,34a.

If the teardrop shaped object 1 is placed in the wind then the working fluid of the atmospheric engine remains water. The water-line is near hole 43.

From the above description it is apparent that the preferred embodiments achieve the object of the present invention. Alternative embodiments and various modifications of the depicted embodiments will be apparent to those skilled in the relevant arts.

1. An energy converting device comprising:
a. a diverging nozzle,
b. an atmospheric engine,
c. a conduit from the small opening of the said diverging nozzle and to said atmospheric engine, and
d. an electric generator operationally connected to said atmospheric engine,
so when said diverging nozzle is placed in the midst of a flowing fluid the velocity of said flowing fluid determines the power output of said electric generator.

2. The device of claim 1 wherein said diverging nozzle comprises:
a. a hollow dome,
b. a hollow shape selected from the group of (1.) dome, and (2) cone,
c. said hollow dome and said hollow shape fixedly attached to each other along their respective rims, said rims being spaced apart and connected intermittently by suitable means, and
d. a hole in the center of said hollow dome, oriented so said hole is parallel with the earth's surface
so as passing fluid draws fluid fluid through the space defined by said rims, fluid is drawn through said hole at a greater velocity than said passing fluid's velocity.

3. An atmospheric engine, comprising:
a. a closed hollow cylinder,
b. a piston slideably located within said cylinder,
c. a piston rod connecting said piston to a cam,
d. a conduit allowing air pressure to press on one side of said piston, and
e. a conduit from an energy sink provided by natural pressure variations in the amount of renewable energy available to operate said atmospheric engine so said pressure variations will be made to operate said atmospheric engine.

4. The device of claim 1 wherein said atmospheric engine comprises:
a. a closed hollow cylinder,
b. a piston slideably located within said cylinder,
c. a piston rod connecting said piston to a cam,
d. two check valves through said piston, one allowing water to flow in one direction,the other allowing fluid to flow in the other direction,
e. a conduit from an energy sink, branching into two conduits, one led through the wall of said cylinder on one side of said piston, the other led through the wall of said cylinder on the other side of said piston,
f. conduits to convey air pressure to the volumes of water on either side of said piston, and
g. valves with suitable controls for said conduits to convey air pressure
so operating said controls will operate said atmospheric engine.
